(19) United States
(12) Patent Application Publication
(10) Pub. No.: US 2004/0064685 A1
(43) Pub. Date: Apr. 1, 2004

(54) System and method for real-time tracing and profiling of a superscalar processor implementing conditional execution

(76) Inventors: Hung Nguyen, Plano, TX (US); Mark Boike, Plano, TX (US)

Correspondence Address: LSI LOGIC CORPORATION, 1621 BARBER LANE, MS: D-106 LEGAL, MILPITAS, CA, 95035, US

(21) Appl. No.: 10/256,597

(22) Filed: Sep. 27, 2002

(51) Int. Cl. G06F 9/00

(52) U.S. Cl. 712/227; 717/128

(57) ABSTRACT

A processor is disclosed including trace and profile logic for gathering and producing data corresponding to events occurring during instruction execution. In one embodiment, the trace and profile logic includes a discontinuity buffer for storing data corresponding to a “discontinuity instruction” subject to grouping with other instructions for simultaneous execution. A “discontinuity instruction” alters, or is executed as a result of an altering of, sequential instruction fetching. In another embodiment, the trace and profile logic includes a serial queue for serializing data corresponding to multiple discontinuity instructions grouped together for simultaneous execution. In another embodiment, the trace and profile logic includes stall filtering logic that asserts an output signal for a time period during which repeated data generated due to a pipeline stall condition are to be ignored. A system is described including the processor, a memory system, an embedded trace module/embedded profile unit (ETM/EPU), and a computer system.

### FIELD OF THE INVENTION

This invention relates generally to data processing, and, more particularly, to apparatus and methods for logging events occurring within, and signals generated and/or received by, a processor during software program execution.

### BACKGROUND OF THE INVENTION

The term “debugging” generally refers to the process of fixing computer problems, and dates back to a requirement to remove moths, attracted by the warmth and glow of vacuum tube filaments, from the circuitry of the first computers. Today, software programs used to trace various events occurring during instruction execution are generally referred to as “debuggers.” Debuggers are typically employed to find causes of problems in software programs.

In general, “tracing” involves logging occurrences of specific events during instruction execution, and “profiling” refers to accumulating performance-related information during instruction execution (e.g., counting numbers of occurrences of specific events, counting amounts of time spent in program routines, etc.). Thus both tracing and profiling generally involve recording specific characteristics of program behavior during instruction execution.

Tracing may involve, for example, recording a sequence in which instructions of a program (i.e., a “target” program) are executed. This type of tracing is generally referred to as “instruction-level tracing” or “instruction tracing.” In this situation, a software interrupt instruction may be inserted between successive instructions of a portion of the target program. An interrupt routine associated with the software interrupt instructions, and executed when the software interrupt instructions are executed, may write target program instruction data to a “trace file.” Following execution of the target program, the trace file contains a record of the sequence in which the instructions of the portion of the target program were executed. A separate “trace regeneration” program may be used to read the trace file and to reproduce the sequence in which the instructions of the portion of the target program were executed.

Alternately, tracing may involve recording a sequence in which certain portions (e.g., routines) of the target program are executed. In this situation, instructions to record executions of the portions of the target program (i.e., “trace instructions”) may be added to the instructions of the target program. The trace instructions may write unique data to the trace file whenever the corresponding portion of the target program is executed. Following execution of the target program, the trace file contains a record of the sequence in which the portions of the target program were executed. The trace regeneration program may be used to read the trace file and to reproduce the sequence in which the portions of the target program were executed.

Profiling may involve, for example, determining how many times each of the portions of the target program was executed. In this case, instructions may be added to the target program that increment count values associated with each of the portions of the target program. As each portions of the target program is executed, the corresponding counter is incremented. In this situation, the result is an execution frequency value for each of the portions of the target program.

Tracing/profiling systems can generally be categorized as either “on-line” (i.e., “real-time”) or “off-line.” The above described tracing and profiling techniques are characteristic of off-line tracing/profiling systems. In off-line tracing/profiling systems, data is written to a file as the target program executes, and later read by other programs. In on-line or real-time tracing/profiling systems, the target program and the other programs run concurrently, and the data is conveyed between them during instruction execution.

It is noted that the above tracing and profiling techniques are considered “intrusive” in that they perturb execution of the target program. For example, the instructions executed to obtain the trace/profile data at least slow down execution of the target program.

Many modern processors employ a technique called pipelining to execute more software program instructions (instructions) per unit of time. In general, processor execution of an instruction involves fetching the instruction (e.g., from a memory system), decoding the instruction, obtaining needed operands, using the operands to perform an operation specified by the instruction, and saving a result. In a pipelined processor, the various steps of instruction execution are performed by independent units called pipeline stages. In the pipeline stages, corresponding steps of instruction execution are performed on different instructions independently, and intermediate results are passed to successive stages. By permitting the processor to overlap the executions of multiple instructions, pipelining allows the processor to execute more instructions per unit of time.

In practice, instructions are often interdependent, and these dependencies often result in “pipeline hazards.” Pipeline hazards result in stalls that prevent instructions from continually entering a pipeline at a maximum possible rate. The resulting delays in pipeline flow are commonly called “bubbles.” The detection and avoidance of hazards presents a formidable challenge to designers of pipeline processors, and hardware solutions can be considerably complex.

There are three general types of pipeline hazards: structural hazards, data hazards, and control hazards. A structural hazard occurs when instructions in a pipeline require the same hardware resource at the same time (e.g., access to a memory unit or a register file, use of a bus, etc.). In this situation, execution of one of the instructions must be delayed while the other instruction uses the resource.

A “data dependency” is said to exist between two instructions when one of the instructions requires a value or data produced by the other. A data hazard occurs in a pipeline when a first instruction in the pipeline requires a value produced by a second instruction in the pipeline, and the value is not yet available. In this situation, the pipeline is typically stalled until the operation specified by the second instruction is completed and the needed value is produced.

A “control dependency” is said to exist between a non-branch/jump instruction and one or more preceding branch/jump instructions that determine whether the non-branch/jump instruction is executed. Conditional branch/jump instructions are commonly used in software programs (i.e., code) to effectuate changes in control flow. A change in control flow is necessary to execute one or more instructions dependent on a condition. Typical conditional branch/jump instructions include “branch if equal,” “jump if not equal,” “branch if greater than,” etc. A control hazard occurs in a pipeline when a next instruction to be executed is unknown, typically as a result of a conditional branch/jump instruction. When a conditional branch/jump instruction occurs, the correct one of multiple possible execution paths cannot be known with certainty until the condition is evaluated. Any incorrect prediction typically results in the need to purge partially processed instructions along an incorrect path from a pipeline, and refill the pipeline with instructions along the correct path.

In general, a “scalar” processor executes instructions one at a time, and a “superscalar” processor is capable of executing multiple instructions simultaneously. A pipelined scalar processor concurrently executes multiple instructions in different pipeline stages; the executions of the multiple instructions are overlapped as described above. A pipelined superscalar processor, on the other hand, concurrently executes multiple instructions in different pipeline stages, and is also capable of concurrently executing multiple instructions in the same pipeline stage. Examples of pipelined superscalar processors include the popular Intel® Pentium®) processors (Intel Corporation, Santa Clara, Calif.) and IBM® PowerPC® processors (IBM Corporation, White Plains, N.Y.).

Conditional branch/jump instructions are commonly used in software programs (i.e., code) to effectuate changes in control flow. A change in control flow is necessary to execute one or more instructions dependent on a condition. Typical conditional branch/jump instructions include “branch if equal,” “jump if not equal,” “branch if greater than,” etc.

A “control dependency” is said to exist between a non-branch/jump instruction and one or more preceding branch/jump instructions that determine whether the non-branch/jump instruction is executed. A control hazard occurs in a pipeline when a next instruction to be executed is unknown, typically as a result of a conditional branch/jump instruction. When a conditional branch/jump instruction occurs, the correct one of multiple possible execution paths cannot be known with certainty until the condition is evaluated. Any incorrect prediction typically results in the need to purge partially processed instructions along an incorrect path from a pipeline, and refill the pipeline with instructions along the correct path.

A software technique called “predication” provides an alternate method for conditionally executing instructions. Predication may be advantageously used to eliminate branch instructions from code, effectively converting control dependencies to data dependencies. If the resulting data dependencies are less constraining than the control dependencies that would otherwise exist, instruction execution performance of a pipelined processor may be substantially improved.

In predicated execution, the results of one or more instructions are qualified dependent upon a value of a preceding predicate. The predicate typically has a value of “true” (e.g. binary ‘1’) or “false” (e.g., binary ‘0’). If the qualifying predicate is true, the results of the one or more subsequent instructions are saved (i.e., used to update a state of the processor). On the other hand, if the qualifying predicate is false, the results of the one or more instructions are not saved (i.e., are discarded).

In some known processors, values of qualifying predicates are stored in dedicated predicate registers, and predicated execution is implemented by associating instructions with predicate registers (i.e., “tagging” instructions along the possible execution paths with an associated predicate register). This tagging is typically performed by a compiler, and requires space (e.g., fields) in instruction formats to specify associated predicate registers. This presents a problem in reduced instruction set computer (RISC) processors typified by fixed-length and densely-packed instruction formats.

Another example of conditional execution involves the TMS320C6x processor family (Texas Instruments Inc., Dallas, Tex.). In the 'C6x processor family, all instructions are conditional. Multiple bits of a field in each instruction are allocated for specifying a condition. If no condition is specified, the instruction is executed. If an instruction specifies a condition, and the condition is true, the instruction is executed. On the other hand, if the specified condition is false, the instruction is not executed. This form of conditional execution also presents a problem in RISC processors in that multiple bits are allocated in fixed-length and densely-packed instruction formats.

### SUMMARY OF THE INVENTION

A processor is disclosed including non-intrusive trace and profile logic having several different features. The trace and profiling logic is “non-intrusive” in that it provides a capability to trace and/or profile a target program in real time (i.e., “at speed”) and without perturbing instruction executions of the target program. In general, the processor fetches and executes instructions, and the trace and profile logic gathers and produces data corresponding to events occurring during instruction execution. In one embodiment, the processor is capable of executing multiple instructions simultaneously (i.e., is a superscalar processor), and the trace and profile logic includes a discontinuity buffer for storing data corresponding to a “discontinuity instruction” subject to grouping with other instructions for simultaneous execution during an instruction grouping stage of an instruction execution pipeline implemented within the processor. In general, a “discontinuity instruction” comprises an instruction that alters, or is executed as a result of an altering of, a sequential fetching of instructions.

In another embodiment of the processor, the trace and profile logic includes a serial queue for serializing (i.e., producing in sequence) data corresponding to multiple discontinuity instructions grouped together for simultaneous execution. In yet another embodiment of the processor, the trace and profile logic includes stall filtering logic that receives at least one input signal indicative of a stall condition in the instruction execution pipeline, and asserts an output signal for a period of time during which repeated, redundant data generated due to the stall condition are to be ignored.

A system is described including a processor, a memory system, an embedded trace module/embedded profile unit (ETM/EPU), and a computer system. The processor is coupled to the memory system via one or more buses, and is configured to fetch instructions from the memory system and to execute the instructions. The processor is capable of executing multiple instructions simultaneously (i.e., is a superscalar processor), and includes the trace and profile logic. The trace and profile logic may include, for example, the discontinuity buffer described above. The ETM/EPU is coupled to the one or more buses and to the processor, and configurable to receive the event data from the processor, and to provide the event data. The computer system receives the event data from the ETM/EPU, and is configurable to present the event data to a user.

### BRIEF DESCRIPTION OF THE DRAWINGS

The invention may be understood by reference to the following description taken in conjunction with the accompanying drawings, in which like reference numerals identify similar elements, and in which:

FIG. 1 is a diagram of one embodiment of a tracing and profiling system including a processor core coupled to a memory system, wherein the processor core fetches instructions of a software program (i.e., “code”) stored in the memory system and executes the instructions, and wherein the code may include a conditional execution instruction and a code block specified by the conditional execution instruction;

FIG. 2 depicts one embodiment of the conditional execution instruction of FIG. 1;

FIG. 3 is a diagram depicting an arrangement of the conditional execution instruction of FIG. 1 and instructions of the code block of FIG. 1 in the code of FIG. 1;

FIG. 4 is a diagram of one embodiment of the processor core of FIG. 1, wherein the processor core includes instruction issue logic;

FIG. 5 is a diagram illustrating an instruction execution pipeline implemented within the processor core of FIG. 4;

FIG. 6 is a diagram of one embodiment of the instruction issue logic of FIG. 4, wherein the instruction issue logic includes trace and profile logic; and

FIG. 7 is a diagram of one embodiment of the trace and profile logic of FIG. 6.

### DETAILED DESCRIPTION OF THE PREFERRED EMBODIMENTS

In the following disclosure, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art. It is further noted that all functions described herein may be performed in either hardware or software, or a combination thereof, unless indicated otherwise. Certain terms are used throughout the following description and claims to refer to particular system components. As one skilled in the art will appreciate, components may be referred to by different names. This document does not intend to distinguish between components that differ in name, but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical or communicative connection. Thus, if a first device couples to a second device, that connection may be through a direct connection, or through an indirect connection via other devices and connections.

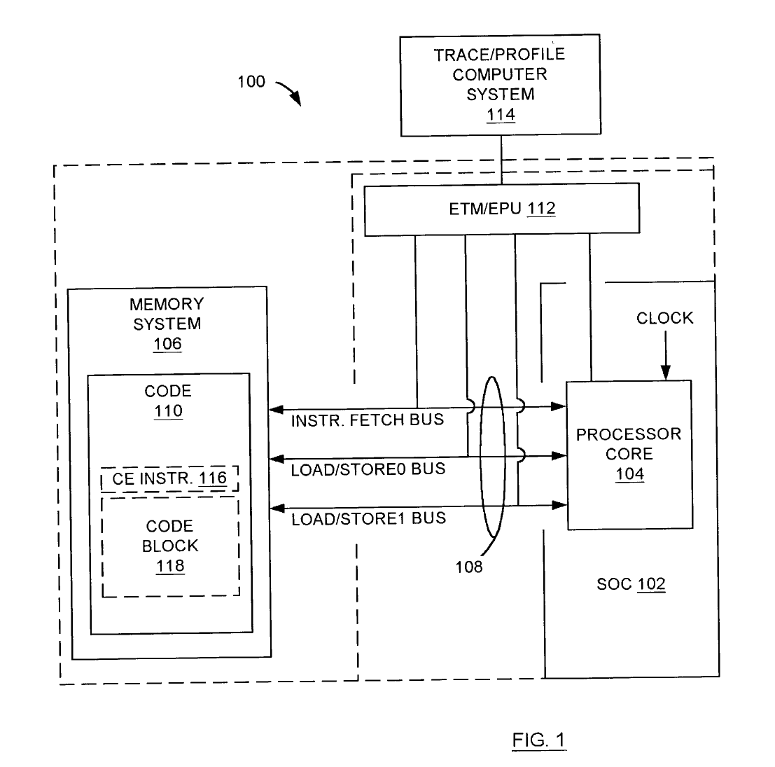

FIG. 1 is a diagram of one embodiment of a tracing and profiling system 100 including a processor core 104 of a system on a chip (SOC) 102 coupled to a memory system 106 via multiple buses 108. The processor core 104 executes instructions of a predefined instruction set. In general, the memory system 106 stores data, wherein the term “data” is understood to include instructions. As indicated in FIG. 1, the processor core 104 receives a CLOCK signal and executes instructions dependent upon the CLOCK signal.

The processor core 104 is both a “processor” and a “core.” The term “core” describes the fact that the processor core 104 is a functional block or unit of the SOC 102. It is now possible for integrated circuit designers to take highly complex functional units or blocks, such as processors, and integrate them into an integrated circuit much like other less complex building blocks. In addition to the processor core 104, the SOC 102 may also include, for example, a phase-locked loop (PLL) circuit for generating the CLOCK signal. The SOC 102 may also include other functional units such as, for example, one or more peripheral interface units for coupling to external peripheral devices, one or more bus interface units (BIUs) for coupling to external buses in addition to the buses 108, a direct memory access (DMA) unit for accessing the memory system 106 substantially independent of the processor core 104, and/or a JTAG (Joint Test Action Group) unit including an IEEE Standard 1149.1 compatible boundary scan access port for circuit-level testing of the SOC 102.

In the embodiment of FIG. 1, the memory system 106 stores a software program (i.e., “code”) 110 including instructions from the instruction set. The processor core 104 and the memory system 106 communicate via signals driven on signal lines of the buses 108. The processor core 104 fetches instructions of the code 110 via an instruction fetch bus of the buses 108, and executes the instructions. During instruction execution, the processor core 104 drives signals upon, and/or receives signals from, the signal lines of the buses 108. 1000361 The tracing and profiling system 100 of FIG. 1 also includes an embedded trace module (ETM)/embedded profile unit (EPU) (i.e., “ETM/EPU”) 112 and a trace/profile computer system 114. The ETM/EPU 112 is coupled to each of the multiple buses 108 and to the processor core 104, and the trace/profile computer system 114 coupled to the ETM/EPU 112. In general, the ETM/EPU 112 is configurable to gather information regarding one or more specific events occurring within the processor core 104, and/or on the signal lines of one or more of the buses 108, during execution of the code 110, and to provide the information to the trace/profile computer system 114. As indicated in FIG. 1, in addition to the processor core 104, the SOC 102 may also include the ETM/EPU 112 and/or the memory system 106.

Examples of events occurring during instruction execution that might be subject to data gathering include events involving accesses of the memory system 106, including data read and write operations, and events occurring within the processor core 104 during instruction execution. Data associated with these events that might be of interest include instruction fetch sequence, instruction execution sequence, the general types of instructions fetched and executed, addresses and/or data values (i.e., signals) generated and/or driven on one or more of the buses 108 during accesses of the memory system 106, and data associated with operations performed within the processor core 104 during instruction execution.

In general, the trace/profile computer system 114 receives the information regarding the specific events from the ETM/EPU 112 and presents the information to a user. For example, the trace/profile computer system 114 may include a processor for processing and/or formatting the information and an output device (e.g., a display screen or a printer). The trace/profile computer system 114 may receive the information regarding the specific events, process and/or format the information, and present the information to the user via the output device.

In the embodiment of FIG. 1, the code 110 may include a conditional execution instruction 116 of the instruction set, and a code block 118 specified by the conditional execution instruction 116. In general, the code block 118 includes one or more instructions selected from the instruction set. The conditional execution instruction 116 also specifies a condition that determines whether execution results of the one or more instructions of the code block 118 are saved in the processor core 104 and/or the memory system 106.

When the code 110 includes the conditional execution instruction 116 and the corresponding code block 118, the processor core 104 fetches the conditional execution instruction 116 from the memory system 106 and executes the conditional execution instruction 116. The conditional execution instruction 116 specifies the code block 118 (e.g., a number of instructions making up the code block 118) and a condition. During execution of the conditional execution instruction 116, the processor core 104 determines the code block 118 and the condition, and evaluates the condition to determine if the condition exists in the processor core 104. The processor core 104 also fetches the instructions of the code block 118 from the memory system 106, and executes each of the instructions of the code block 118, producing corresponding execution results within the processor core 104. The execution results of the instructions of the code block 118 are saved in the processor core 104 and/or the memory system 106 dependent upon the existence of the condition specified by the conditional execution instruction 116 in the processor core 104. In other words, the condition specified by the conditional execution instruction 116 qualifies the writeback of the execution results of the instructions of the code block 118. The instructions of the code block 118 may otherwise traverse the pipeline normally. The results of the instructions of the code block 118 are used to change a state of the processor core 104 and/or the memory system 106 only if the condition specified by the conditional execution instruction 116 exists in the processor core 104.

In the embodiment of FIG. 1, the processor core 104 implements a load-store architecture. That is, the instruction set includes load instructions used to transfer data from the memory system 106 to registers of the processor core 104, and store instructions used to transfer data from the registers of the processor core 104 to the memory system 106. Instructions other than the load and store instructions specify register operands, and register-to-register operations. In this manner, the register-to-register operations are decoupled from accesses to the memory system 106.

The memory system 106 may include, for example, volatile memory structures (e.g., dynamic random access memory structures, static random access memory structures, etc.) and/or non-volatile memory structures (read only memory structures, electrically erasable programmable read only memory structures, flash memory structures, etc.).

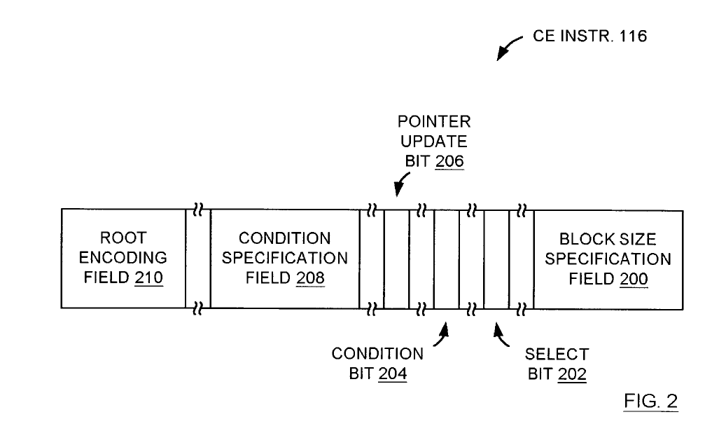

FIG. 2 depicts one embodiment of the conditional execution instruction 116 of FIG. 1. In the embodiment of FIG. 2, the conditional execution instruction 116 and the one or more instructions of the code block 118 of FIG. 1 are fixed-length instructions (e.g., 16-bit instructions), and the instructions of the code block 118 immediately follow the conditional execution instruction 116 in the code 110 of FIG. 1. It is noted that other embodiments of the conditional execution instruction 116 of FIG. 1 are possible and contemplated.

In the embodiment of FIG. 2, the conditional execution instruction 116 includes a block size specification field 200, a select bit 202, a condition bit 204, a pointer update bit 206, a condition specification field 208, and a root encoding field 210. The block size specification field 200 is used to store a value indicating a number of instructions immediately following the conditional execution instruction 116 and making up the code block 118 of FIG. 1. The block size specification field 200 may be, for example, a 3-bit field specifying a code block including from 1 (block size specification field=“000”) to 8 (block size specification field=“111”) instructions immediately following the conditional execution instruction 116.

As described in detail below, the processor core 104 of FIG. 1 includes multiple flag registers and multiple general purpose registers. A value of the select bit 202 indicates whether the condition specified by the conditional execution instruction 116 of FIG. 1 is stored in a flag register or in a general purpose register. For example, if the select bit 202 is a ‘0,’ the select bit 202 may indicate that the condition specified by the conditional execution instruction 116 of FIG. 1 is stored in a flag register. On the other hand, if the select bit 202 is a ‘1,’ the select bit 202 may indicate that the condition specified by the conditional execution instruction 116 of FIG. 1 is stored in a general purpose register.

In general, the condition bit 204 specifies a value used to qualify the execution results of the instructions in the code block 118. For example, if the condition bit 204 is a ‘0,’ the execution results of the instructions of the code block 118 of FIG. 1 may be qualified (i.e., stored) only if a value stored in a specified register of the processor core 104 of FIG. 1 is equal to ‘0’ during execution of the conditional execution instruction 116. On the other hand, if the condition bit 204 is a ‘1,’ the execution results of the instructions of the code block 118 may be stored only if the value stored in the specified register is equal to ‘1.’

For example, when the select bit 202 indicates that the condition specified by the conditional execution instruction 116 of FIG. 1 is stored in a flag register and the condition bit 204 is a ‘0,’ the condition specified by the conditional execution instruction 116 may be that the value of a specified flag bit in a specified flag register is ‘0.’ Similarly, when the select bit 202 indicates that the condition specified by the conditional execution instruction 116 of FIG. 1 is stored in a general purpose register and the condition bit 204 is a ‘0,’ the condition specified by the conditional execution instruction 116 may be that the value stored in the specified general purpose register is ‘0.’

In a similar manner, when the select bit 202 indicates that the condition specified by the conditional execution instruction 116 of FIG. 1 is stored in a flag register and the condition bit 204 is a ‘1,’ the condition specified by the conditional execution instruction 116 may be that the value of the specified flag bit in the specified flag register is ‘1.’ Similarly, when the select bit 202 indicates that the condition specified by the conditional execution instruction 116 of FIG. 1 is stored in a general purpose register and the condition bit 204 is a ‘1,’ the condition specified by the conditional execution instruction 116 may be that the value stored in the specified general purpose register is ‘1.’

The processor core 104 of FIG. 1 is configured to execute load/store with update instructions described above. In some load/store with update instructions, the contents of a general purpose register of the processor core 104 is used as an address (i.e., a pointer) to access a memory location in the memory system 106 of FIG. 1. A value (e.g., an index value) is then added to the contents of the general purpose register (i.e., the pointer is updated) such that the contents of the general purpose register is an address of a next sequential value in the memory system 106.

For example, a set of instructions executable by the processor core 104 of FIG. 1 may include a load with update instruction ‘ldu’ having the following syntax: ldu rX, rY, n. In a first operation specified by the ‘Idu’ instruction, the contents of a first general purpose register ‘rY’ of the processor core 104 is used as an address (i.e., a pointer) to access a memory location in the memory system 106 of FIG. 1, and a value stored in the memory location is saved in a second general purpose register ‘rX’ of the processor core 104. In a second operation specified by the ‘Idu’ instruction, the integer value ‘n’ is added to the contents of the register ‘rY’, and the result is stored in the register ‘rY’ such that the contents of the register ‘rY’ is an address of a next sequential value in the memory system 106 (i.e., the pointer is updated).

Other load/store with update instructions exist in the set of instructions executable by the processor core 104 of FIG. 1. In general, the load/store with update instructions are distinguished from other load/store instructions in that in addition to loading a value from a memory location into a general purpose register of the processor core 104, or storing a value in a general purpose register to a memory location, the load/store with update instructions also modify an address (i.e., update a pointer) stored in a separate general purpose register of the processor core 104.

In general, the pointer update bit 206 indicates whether general purpose registers of the processor core 104 used to store memory addresses (i.e., pointers) are to be updated in the event the code block 118 of FIG. 1 includes one or more load/store instructions. For example, when the update bit 206 has a value of ‘0’, the pointer update bit 206 may specify that any pointers in any load/store instructions of the code block 118 are to be updated only if the condition specified by the conditional execution instruction 116 of FIG. 1 is true. In this situation, when the pointer update bit 206 has a value of ‘0’ and the condition specified by the conditional execution instruction 116 is false, the pointers in any load/store instructions of the code block 118 are not updated.

When the pointer update bit 206 has a value of ‘1’, the pointer update bit 206 may specify that any pointers in any load/store instructions of the code block 118 of FIG. 1 are to be updated unconditionally (e.g., independent of the condition specified by the conditional execution instruction 116 of FIG. 1). In this situation, if the pointer update bit 206 has a value of ‘1’, the pointers in any load/store instructions of the code block 118 are updated regardless of whether the condition specified by the conditional execution instruction 116 of FIG. 1 is true or false.

In general, the condition specification field 208 specifies either a particular flag bit in a particular flag register, or a particular one of the multiple general purpose registers of the processor core 104. For example, when the select bit 202 indicates that the condition specified by the conditional execution instruction 116 of FIG. 1 is stored in a flag register, the condition specification field 208 specifies a particular one of the multiple flag registers of the processor core 104 of FIG. 1, and a particular one of several flag bits in the specified flag register. When the select bit 202 indicates that the condition specified by the conditional execution instruction 116 of FIG. 1 is stored in a general purpose register, the condition specification field 208 specifies a particular one of the multiple general purpose registers of the processor core 104 of FIG. 1.

As described in more detail below, the processor core 104 of FIG. 1 includes two flag registers: a hardware flag register ‘HWFLAG’ and a static hardware flag register ‘SHWFLAG.’ Both the HWFLAG and the SHWFLAG registers store the following flag bits:

| | |
|---|---|
| v = | 32-Bit Overflow Flag. Cleared (i.e., ‘0’) when a sign of a result of a twos- |
| | complement addition is the same as signs of 32-bit operands (where both |
| | operands have the same sign); set (i.e., ‘1’) when the sign of the result differs |
| | from the signs of the 32-bit operands. |
| gv = | Guard Register 40-Bit Overflow Flag. (Same as the ‘v’ flag bit described |
| | above, but for 40-bit operands.) |
| sv = | Sticky Overflow Flag. (Same as the ‘v’ flag bit described above, but once set, |
| | can only be cleared through software by writing a ‘0’ to the ‘sv’ bit.) |
| gsv = | Guard Register Sticky Overflow Flag. (Same as the ‘gv’ flag bit described |
| | above, but once set, can only be cleared through software by writing a ‘0’ to |
| | bit.) the ‘gsv’ |
| c = | Carry Flag. Set when a carry occurs during a twos-complement addition for 16- |
| | bit operands; cleared when no carry occurs. |
| ge = | Greater Than Or Equal To Flag. Set when a result is greater than or equal to |
| | zero; cleared when the result is not greater than or equal to zero. |
| gt = | Greater Than Flag. Set when a result is greater than zero; cleared when the |
| | result is not greater than zero. |
| z = | Equal to Zero Flag. Set when a result is equal to zero; cleared when the result is |
| | not equal to zero. |

Table 1 below lists ememplary encodings of the condition specification field 208 valid when the select bit 202 indicates that the condition specified by the conditional execution instruction 116 of FIG. 1 is stored in a flag register:

TABLE 1
Exemplary Encodings of the Condition specification field 208
Valid When the Select Bit 202 Indicates the Condition
Is Stored in a Flag Register.

| Cond. Spec. | Specified | Specified |
|---|---|---|
| Field 206 | Flag | Flag |
| Value | Register | Bit |
| 0000 | HWFLAG | v |
| 0001 | HWFLAG | gv |
| 0010 | HWFLAG | sv |
| 0011 | HWFLAG | gsv |
| 0100 | HWFLAG | c |
| 0101 | HWFLAG | ge |
| 0118 | HWFLAG | gt |
| 0111 | HWFLAG | z |
| 1000 | SHWFLAG | v |
| 1001 | SHWFLAG | gv |
| 1010 | SHWFLAG | sv |
| 1011 | SHWFLAG | gsv |
| 1180 | SHWFLAG | c |
| 1181 | SHWFLAG | ge |
| 1118 | SHWFLAG | gt |
| 1111 | SHWFLAG | z |

For example, referring to Table 1 above, when the select bit 202 indicates that the condition specified by the condtional execution instruction 116 of FIG. 1 is stored in a flag register, a ‘0101’ encoding of the condition specification field 208 of the conditional execution instruction 116 specified the hardware flag register and the ‘ge’ flag bit of the hardware flag register. If the condition bit 204 indicates the specified value must be a ‘1,’ and the ‘ge’ flag bit of the hardware flag register is ‘1’ during execution of the conditional execution instruction 116, the execution results of the instructions of the code black 118 of FIG. 1 are saved. On the other hand, if the ‘ge’ flag bit of the hardware flag register is ‘0’ during execution of the conditional execution instruction 116, the execution results of the instructions of the code block 118 of FIG. 1 are not saved (i.e., the execution results are discarded).

As described in more detail below, the processor core 104 of FIG. 1 also includes 16 general purpose registers (GPRs) numbered ‘0’ through ‘15.’ Table 2 below lists exemplary encodings of the condition specification field 208 valid when the select bit 202 indicates that the condition specified by the conditional execution instruction 116 of FIG. 1 is stored in a general purpose register.

TABLE 2
Exemplary Encodings of the Condition specification field 208
Valid When the Select Bit 202 Indicates the Condition
Is Stored in a General Purpose Register.

| Cond. Spec. | |
|---|---|
| Field 206 | Specified |
| Value | GPR |
| 0000 | GPR 0 |
| 0001 | GPR 1 |
| 0010 | GPR 2 |
| 0011 | GPR 3 |
| 0100 | GPR 4 |
| 0101 | GPR 5 |
| 0118 | GPR 6 |
| 0111 | GPR 7 |
| 1000 | GPR 8 |
| 1001 | GPR 9 |
| 1010 | GPR 10 |
| 1011 | GPR 11 |
| 1180 | GPR 12 |
| 1181 | GPR 13 |
| 1118 | GPR 14 |
| 1111 | GPR 15 |

For example, referring to Table 2 above, when the select bit 202 indicates that the condition specified by the conditional execution instruction 116 of FIG. 1 is stored in a general purpose register, a ‘1011’ endcoding of the condition specification field 208 of the conditional execution instruction 116 specifies the GPR 11 register of the processor core 104 of FIG. 1. If the condition bit 204 indicates the specified value must be a ‘1,’ and the GPR 11 register contains a ‘1’ during execution of the conditional execution instruction 116, the execution results of the instructions of the code block 118 of FIG. 1 are saved. On the other hand, if the GPR 11 register contains a ‘0’ during execution of the conditional execution instruction 116, the execution results of the instructions of the code block 118 of FIG. 1 are not saved (i.e., the execution results are discarded).

The root encoding field 210 identifies an operation code (opcode) of the conditional execution instruction 116 of FIG. 2. In other embodiments of the conditional execution instruction 116, the root encoding field 210 may also help define the condition specified by the conditional execution instruction 116. For example, the root encoding field 210 may also specify a particular group of registers within the processor core 104 of FIG. 1 and/or a particular register within the processor core 104.

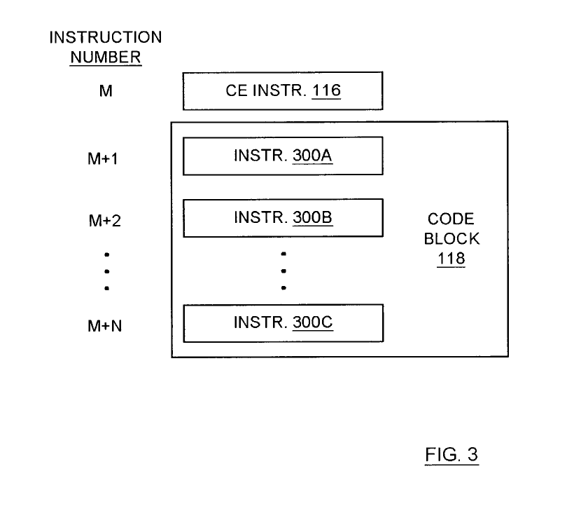

FIG. 3 is a diagram depicting an arrangement of the conditional execution instruction 116 of FIG. 1 and instructions of the code block 118 of FIG. 1 in the code 110 of FIG. 1. In the embodiment of FIG. 3, the code block includes n instructions. The conditional execution instruction 116 is instruction number m in the code 110, and the n instructions of the code block 118 includes instructions 300A, 300B, and 300C. The instruction 300A immediately follows the conditional execution instruction 116 in the code 110, and is instruction number m+1 of the code 110. The instruction 300B immediately follows the instruction 300A in the code 110, and is instruction number m+2 of the code 110. The instruction 300C is instruction number m+n of the code 110, and is the nth (i.e., last) instruction of the code block 118.

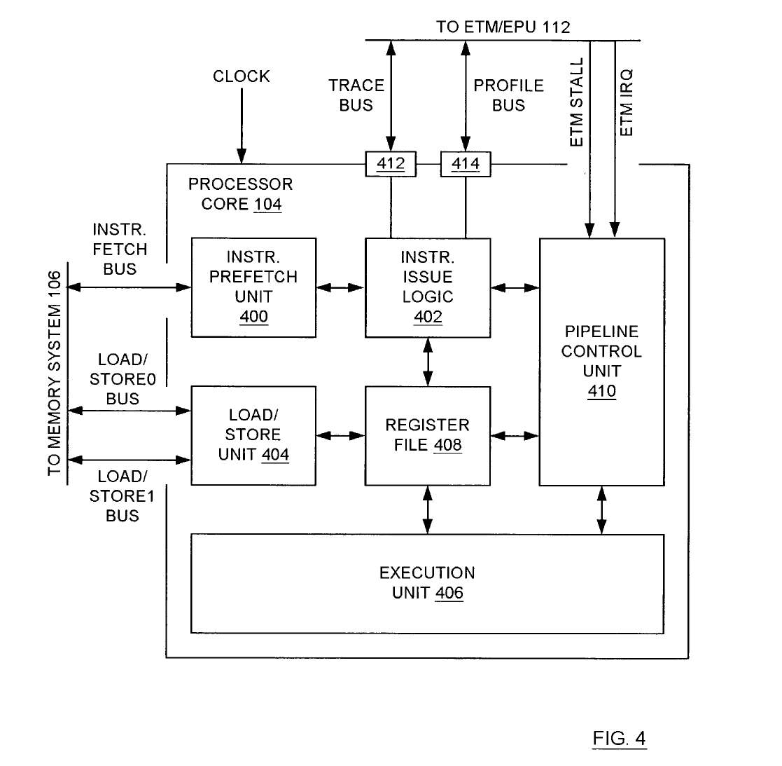

FIG. 4 is a diagram of one embodiment of the processor core 104 of FIG. 1. In the embodiment of FIG. 4, the processor core 104 includes an instruction prefetch unit 400, instruction issue logic 402, a load/store unit 404, an execution unit 406, a register file 408, and a pipeline control unit 410. In the embodiment of FIG. 4, the processor core 104 is a pipelined superscalar processor core. That is, the processor core 104 implements an instruction execution pipeline including multiple pipeline stages, concurrently executes multiple instructions in different pipeline stages, and is also capable of concurrently executing multiple instructions in the same pipeline stage.

In general, the instruction prefetch unit 400 fetches instructions from the memory system 106 of FIG. 1, and provides the fetched instructions to the instruction issue logic 402. In one embodiment, the instruction prefetch unit 400 is capable of fetching up to 8 instructions at a time from the memory system 106, partially decodes the instructions, and stores the partially decoded instructions in an instruction cache within the instruction prefetch unit 400.

The instruction issue logic 402 decodes the instructions and translates the opcode to a native opcode, then stores the decoded instructions in the instruction queue 506 (as described below). The load/store unit 404 is used to transfer data between the processor core 104 and the memory system 106 as described above. The execution unit 406 is used to perform operations specified by instructions (and corresponding decoded instructions). In one embodiment, the execution unit 406 of FIG. 4 includes an arithmetic logic unit (ALU), a multiply-accumulate unit (MAU), and a data forwarding unit (DFU). The register file 408 includes multiple registers of the processor core 104, and is described in more detail below. In general, the pipeline control unit 410 controls the instruction execution pipeline described in more detail below.

In one embodiment, the instruction issue logic 402 is capable of receiving (or retrieving) n partially decoded instructions (n>1) from the instruction cache within the instruction prefetch unit 400 of FIG. 4, and decoding the n partially decoded instructions, during a single cycle of the CLOCK signal. The instruction issue logic 402 then issues the n instructions as appropriate.

In one embodiment, the instruction issue logic 402 decodes instructions and determines what resources within the execution unit 406 are required to execute the instructions (e.g., an arithmetic logic unit or ALU, a multiply-accumulate unit or MAU, etc.). The instruction issue logic 402 also determines an extent to which the instructions depend upon one another, and queues the instructions for execution by the appropriate resources of the execution unit 406.

As described above, the register file 408 of FIG. 4 includes a hardware flag register and a static hardware flag register. Both the a hardware flag register and the static hardware flag register include the flag bits ‘v’, ‘gv’, ‘sv’, ‘gsv’, ‘c’, ‘ge’, ‘gt’, and ‘z’ described above. The hardware flag register 504 is updated during instruction execution such that the flag bits in the hardware flag register 504 reflect a state or condition of the processor core 104 of FIGS. 1 and 4 resulting from instruction execution. The static hardware flag register, on the other hand, is updated only when a conditional execution instruction in the code 110 of FIG. 1 (e.g., the conditional execution instruction 116 of FIGS. 1 and 3) specifies the hardware flag register.

In the embodiment of FIG. 4, the processor core 104 also includes a trace port 412 and a profile port 414. In general, the trace port 412 is adapted for coupling to a trace bus. In FIG. 1, the processor core 104 and the ETM/ETU 112 exchange trace information (e.g., trace event specification information, trace data, etc.) via signals driven on signal lines of the trace bus. The profile port 414 is adapted for coupling to a profile bus. In FIG. 1, the processor core 104 and the ETM/ETU 112 exchange profile information (e.g., profile event specification information, profile data, etc.) via signals driven on signal lines of the profile bus. As indicated in FIG. 4, and described in more detail below, the instruction issue logic 402 is coupled to the trace port 412 and the profile port 414, and logic within the instruction issue logic 402 generates signals driven on, and receives signals from, signal lines of the trace and profile buses.

Table 1 below lists the names and descriptions of signals conveyed via terminals (i.e., “pins”) of the trace port 412:

TABLE 1
Trace Port 412 Signal Names and Descriptions.

| Signal Name | Description |
|---|---|
| isu_pc0_rd[23:0] | Program counter for slot0 in RD pipeline stage. |
| isu_pc1_rd[23:0] | Program counter for slot1 in RD pipeline stage. |
| isu_pc2_rd[23:0] | Program counter for slot2 in RD pipeline stage. |
| isu_pc3_rd[23:0] | Program counter for slot3 in RD pipeline stage. |
| isu_pc4_rd[23:0] | Program counter for slot4 in RD pipeline stage. |
| isu_pc5_rd[23:0] | Program counter for slot5 in RD pipeline stage. |
| isu_inst_vld_rd[5:0] | Number of valid instructions in RD pipeline stage. |
| cpu_etm_exc_trace_wb[7:0] | Execution trace packet in WB pipeline stage: |
| | Bits [7:5] - Instruction Type: |
| | 000 - No discontinuity instruction executed. |
| | 001 - BR IMM or Bcc IMM (unconditional or |
| | conditional branch). |
| | 010 - CALL IMM. |
| | 011 - AGNx (Hardware loop instruction). |
| | 100 - CALL Rx/Ax (Register-based subroutine call). |
| | 101 - BR Rx/aX (Register-based unconditional |
| | branch). |
| | 110 - Interrupt is taken. |
| | 111 - RET or RETI. |
| | Bits [4:3] - Conditional execution block 0 (CEXE0): |
| | 0x - No conditional execution. |
| | 10 - CEXE0 block not executed. |
| | 11 - CEXE0 block executed. |
| | Bits [2:1] - Conditional execution block 1 (CEXE1): |
| | 0x - No conditional execution. |
| | 10 - CEXE1 block not executed |
| | 11 - CEXE1 block executed. |
| | Bit [0] - Discontinuity instruction is taken: |
| | 0 - Discontinuity instruction is not taken. |
| | 1 - Discontinuity instruction is taken. |
| cpu_disc_pc_wb[23:0] | The discontinuity program counter. It is the new PC value if |
| | non-sequential execution is performed. It is valid |
| | whenever there is a change in the instruction flow. Note that |
| | this is the taken PC for a conditional branch. |

Table 2 below lists names and descriptions of signals conveyed via terminals (i.e., “pins”) of the profile port 414:

TABLE 2
Profile Port 414 Signal Names and Descriptions.

| Signal Name | Description |
|---|---|
| Cpt_etm_{—} | Profile Trace: |
| prof_wb[10:0] | Bits [10:8] - Number of instructions executed. |
| | Bit [7] - Active Interrupt is masked. |
| | Bit [6] - Interrupts are disabled. |
| | Bit [5] - Memory stall. |
| | Bit [4] - Branch taken. |
| | Bit [3] - Conditional branch mispredicted. |
| | Bit [2] - Branch executed. |
| | Bit [1:0] - Number of multiply-accumulate |
| | instructions (MACs) executed: |
| | 00 - None. |
| | 01 - one in MAC0 or MAC1. |
| | 10 - one in MAC0 and MAC1. |
| | 11 - Reserved. |
| cpu_icache_hit_fd | Indicates an instruction fetch hit in |
| | the instruction cache. |

As indicated in FIG. 4, the pipeline control unit 410 receives an ETM STALL signal and an ETM IRQ signal from the ETM/EPU 112. The ETM/EPU 112 asserts the ETM STALL when a buffer of the tracing and profiling system 100 of FIG. 1 and used to store trace/profile information is full and needs to be emptied before more trace/profile information is generated. The pipeline control unit 410 responds to the asserted ETM STALL signal by stalling the execution pipeline.

The ETM/EPU 112 asserts the ETM IRQ signal when an interrupt service routine needs to be executed. The pipeline control unit 410 responds to the asserted ETM IRQ signal by halting execution of instruction of the code 110 (FIG. 1) and executing instructions of the interrupt service routine. The instructions of the interrupt service routine may, for example, cause the processor core 104 to write data otherwise not visible to the ETM/EPU 112 (e.g., register data) to the memory system 106. Such data becomes visible to the ETM/EPU 112 when driven on the load/storeO bus or the load/store 1 bus shown in FIG. 1.

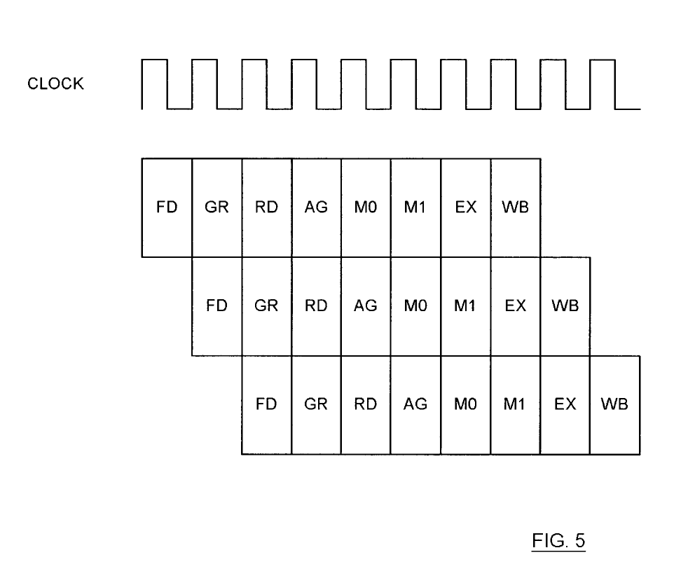

FIG. 5 is a diagram illustrating the instruction execution pipeline implemented within the processor core 104 of FIG. 4. The instruction execution pipeline (pipeline) allows overlapped execution of multiple instructions. In the example of FIG. 5, the pipeline includes 8 stages: a fetch/decode (FD) stage, a grouping (GR) stage, an operand read (RD) stage, an address generation (AG) stage, a memory access 0 (MO) stage, a memory access 1 (M1) stage, an execution (EX) stage, and a write back (WB) stage. As indicated in FIG. 5, operations in each of the 8 pipeline stages are completed during a single cycle of the CLOCK signal.

Referring to FIGS. 4 and 5, the instruction fetch unit 400 fetches several instructions (e.g., up to 8 instructions in one embodiment) from the memory system 106 of FIG. 1 during the fetch/decode (FD) pipeline stage, partially decodes and aligns the instructions, and provides the partially decoded instructions to the instruction issue logic 402. The instruction issue logic 402 fully decodes the instructions and stores the fully decoded instructions in an instruction queue (described more fully later). The instruction issue logic 402 also translates the opcodes into the native opcodes for the processor.

During the grouping (GR) stage, the instruction issue logic 402 checks the multiple decoded instructions for grouping and dependency rules, and passes one or more of the decoded instructions conforming to the grouping and dependency rules on to the read operand (RD) stage as a group. During the read operand (RD) stage, any operand values, and/or values needed for operand address generation, for the group of decoded instructions are obtained from the register file 408.

During the address generation (AG) stage, any values needed for operand address generation are provided to the load/store unit 404, and the load/store unit 404 generates internal addresses of any operands located in the memory system 106 of FIG. 1. During the memory address 0 (M0) stage, the load/store unit 404 translates the internal addresses to external memory addresses used within the memory system 106 of FIG. 1.

During the memory address 1 (M1) stage, the load/store unit 404 uses the external memory addresses to obtain any operands located in the memory system 106 of FIG. 1. During the execution (EX) stage, the execution unit 406 uses the operands to perform operations specified by the one or more instructions of the group. During a final portion of the execution (EX) stage, valid results (including qualified results) are stored in registers of the register file 408.

During the write back (WB) stage, valid results (including qualified results) of store instructions, used to store data in the memory system 106 of FIG. 1 as described above, are provided to the load/store unit 404. Such store instructions are typically used to copy values stored in registers of the register file 408 to memory locations of the memory system 106.

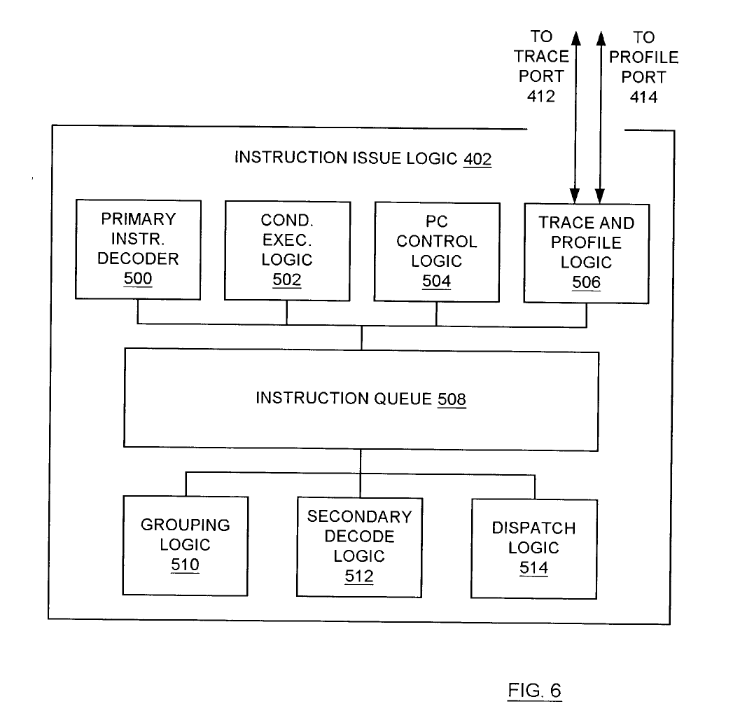

FIG. 6 is a diagram of one embodiment of the instruction issue logic 402 of FIG. 4. In the embodiment of FIG. 6, the instruction issue logic 402 includes a primary instruction decoder 500, conditional execution logic 502, program counter (PC) control logic 504, trace and profile logic 506, an instruction queue 508, grouping logic 510, secondary decode logic 512, and dispatch logic 514.

In one embodiment, the primary instruction decoder 500 includes an n-slot queue (n>1) for storing partially decoded instruction received (or retrieved) from the instruction prefetch unit 400 of FIG. 4 (e.g., from an instruction queue of the instruction prefetch unit 400). Each of the n slots has dedicated decode logic associated with it. Up to n instructions occupying the n slots are fully decoded during the fetch/decode (FD) stage of the pipeline and are stored in the instruction queue 508.

In the grouping (GR) stage of the pipeline, the primary instruction queue 508 provides fully decoded instructions (e.g., from the n-slot queue) to the grouping logic 510. The grouping logic 510 performs dependency checks on the fully decoded instructions by applying a predefined set of dependency rules (e.g., write-after-write, read-after-write, write-after-read, etc.). The set of dependency rules determine which instructions can be grouped together for simultaneous execution (e.g., execution in the same cycle of the CLOCK signal).

The conditional execution logic 502 identifies conditional execution instructions (e.g., the conditional execution instruction 116 of FIG. 1) and tags instructions of the code blocks specified by the conditional execution instructions. For example, referring back to FIG. 3, the condtional execution logic 502 would tag the instructions 300A and 300C of the code block 118 specified by the conditional execution instruction 116. When instructions in code blocks specified by conditional execution instructions enter the grouping (GR) pipeline stage, they are identified (i.e. tagged) to ensure that the grouping logic 510 groups them for conditional execution.

In general, the program counter (PC) control logic 504 stores several program counter (PC) values used to track instruction execution activities within the processor core 104 of FIGS. 1 and 4. In one embodiment, the program counter (PC) control logic 504 includes a program counter (PC) register, a trap PC (TPC) register used to store a return address when an interrupt is asserted, and a return PC (RPC) register used to store a return address when a CALL software program instruction occurs in the code 110 of FIG. 1. In one embodiment, the PC, TPC, and RPC registers have corresponding queues: a PC queue, a TPC queue, and an RPC queue, and the PC control logic 504 includes logic to update the PC, TPC, and RPC registers and the corresponding queues. In one embodiment, the PC control logic 504 also includes a branch mispredict PC register, a corresponding mispredict queue, and logic to keep track of branch mispredictions.

The instruction queue 508 is used to store fully decoded instructions (i.e., “instructions”) which are queued for grouping and dispatch to the pipeline. In one embodiment, the instruction queue 508 includes n slots and instruction ordering multiplexers. The number of instructions stored in the instruction queue 508 varies over time dependent upon the ability to group instructions. As instructions are grouped and dispatched from the instruction queue 508, newly coded instructions received from the primary instruction decoder 500 may be stored in empty slots of the instruction queue 508.

The secondary decode logic 512 includes additional instruction decode logic used in the grouping (GR) stage, the operand read (RD) stage, the memory access 0 (MO) stage, and the memory access 1 (M1) stage of the pipeline. In general, the additional instruction decode logic provides additional information from the opcode of each instruction to the grouping logic 510. For example, the secondary decode logic 512 may be configured to find or decode a specific instruction or group of instructions to which a grouping rule can be applied.

In one embodiment, the dispatch logic 514 queues relevant information such as native opcodes, read control signals, or register addresses for use by the execution unit 406, register file 408, and load/store unit 404 at the appropriate pipeline stage.

In general, the trace and profile logic 506 includes logic to obtain trace and/or profile information while the processor core of FIGS. 1 and 4 executes the instructions of the code 110 of FIG. 1. The trace and profile logic 506 is coupled to the trace port 412 of FIG. 4 and the profile port 414 of FIG. 4 as indicated in FIG. 6, and logic within the trace and profile logic 506 generates the signals driven on, and receives signals from, signal lines of the trace bus 412 and the profile bus 414 as described above. (See tables 1 and 2 above.)

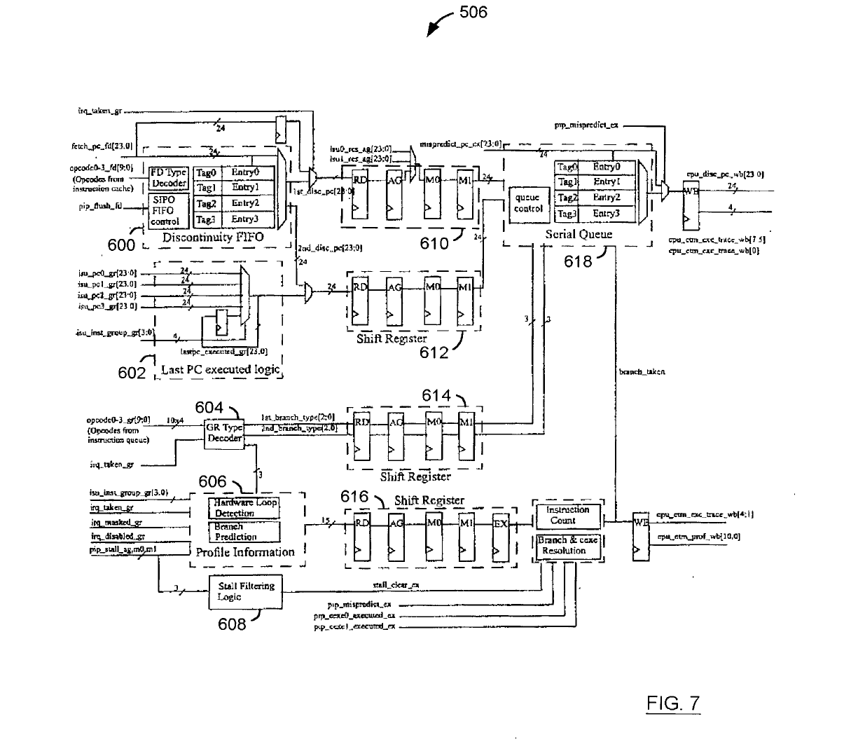

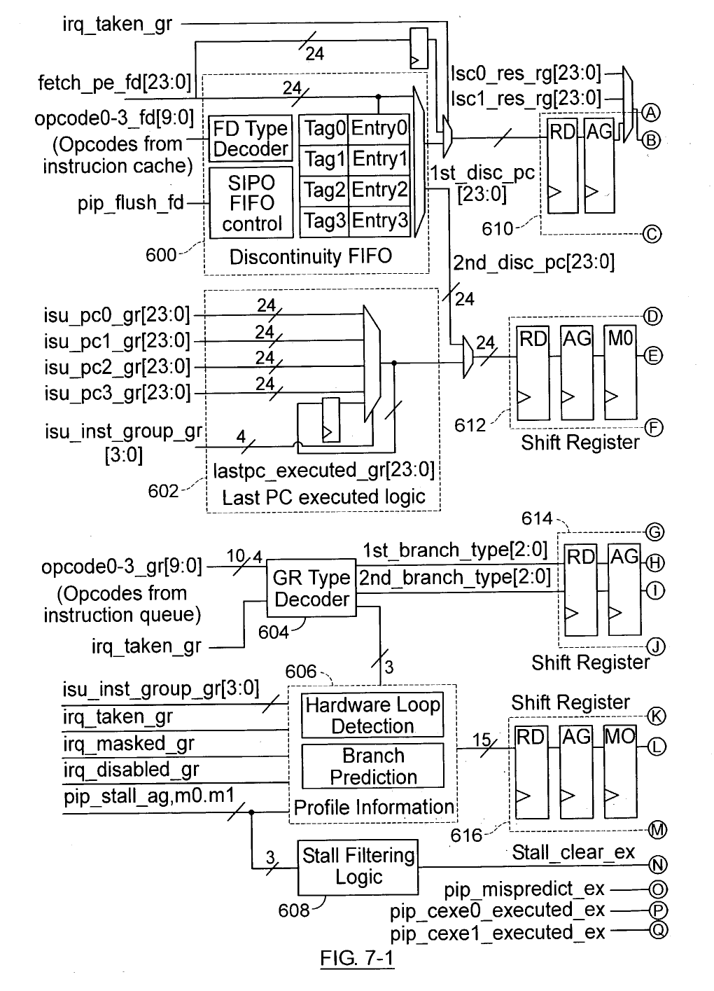

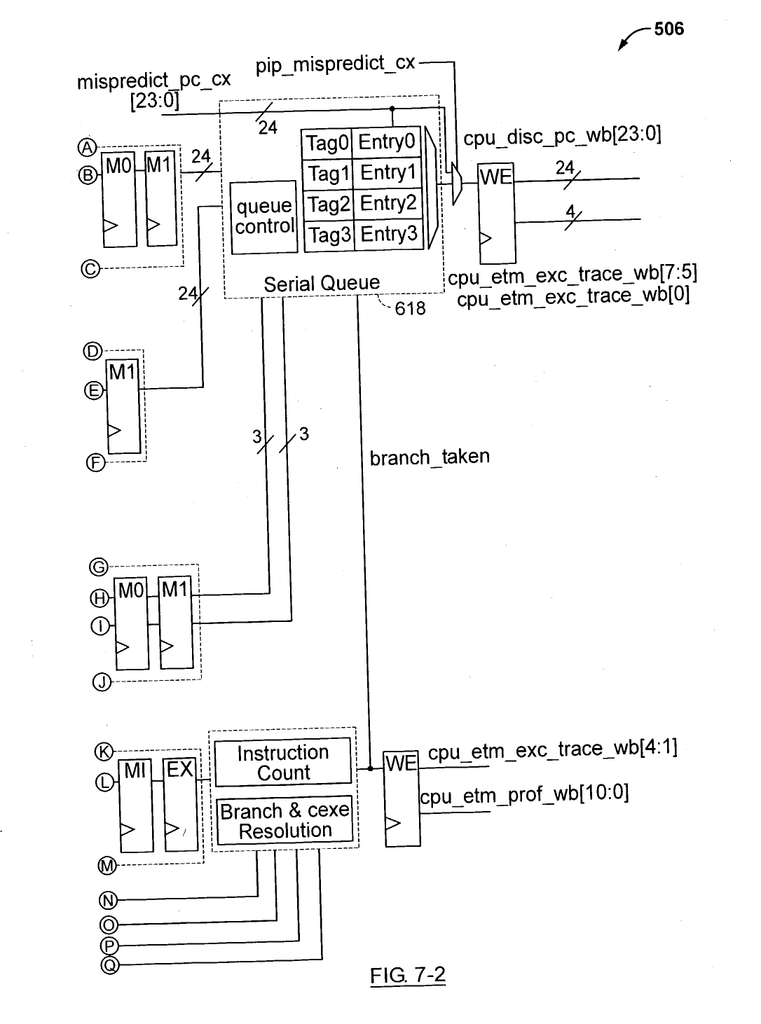

FIG. 7 is a diagram of one embodiment of the trace and profile logic 506 of FIG. 6. Table 3 below lists the names and descriptions of input and output signals of the embodiment of the trace and profile logic 506 of FIG. 7:

TABLE 3
Input and Output Signals of the Trace and Profile Logic 506 of FIG. 7.

| Signal Name | Description |
|---|---|
| fetch_pc_fd[23:0] | Instruction fetch program counter. |
| isu_pc0_gr[23:0] | Slot0 Program Counter in GR pipeline stage. |
| isu_pc1_gr[23:0] | Slot1 Program Counter in GR pipeline stage. |
| isu_pc2_gr[23:0] | Slot2 Program Counter in GR pipeline stage |
| isu_pc3_gr[23:0] | Slot3 Program Counter in GR pipeline stage |
| isu_inst_group_gr[3:0] | Number of instructions that are grouped in GR |
| | stage. Only these instructions will continue on to the next |
| | pipeline stage. |
| opcode0_fd[9:0] | Instruction opcode for slot0 from instruction cache. |
| opcode1_fd[9:0] | Instruction opcode for slot1 from instruction cache. |
| opcode2_fd[9:0] | Instruction opcode for slot2 from instruction cache. |
| opcode3_fd[9:0] | Instruction opcode for slot3 from instruction cache. |
| opcode0_gr[9:0] | Instruction opcode for slot0 from instruction queue. |
| opcode1_gr[9:0] | Instruction opcode for slot1 from instruction queue. |
| opcode2_gr[9:0] | Instruction opcode for slot2 from instruction queue. |
| opcode3_gr[9:0] | Instruction opcode for slot3 from instruction queue. |
| pip_flush_fd | pipeline flush signal. ISU flushes all instructions in FD and |
| | GR pipeline stage upon receiving this signal. |
| lsu0_res_ag[23:0] | Load/Store Unit 0 (LSU0) result bus. |
| lsu1_res_ag[23:0] | Load/Store Unit 1 (LSU1) result bus. |
| pip_mispredict_ex | This signal indicates that the path taken by a conditional |
| | branch was incorrectly predicted. When this occurs, the |
| | fetch_pc_fd will be updated with the |
| | mispredict_pc_ex below. |
| mispredict_pc_ex[23:0] | This is the correct PC for a conditional branch that was |
| | mispredicted. |
| irq_taken_gr | An interrupt is to be serviced in GR pipeline stage. |
| irq_masked_gr | An interrupt is not going to be serviced because it is masked |
| | out. This signal can be generalized to any core internal event |
| | of interest. |
| irq_disabled_gr | An interrupt is not going to be serviced because it is |
| | disabled. This signal can be generalized to any core internal |
| | event of interest. |
| pip_cexe0_executed_ex | This signal indicates that a conditional block0 is executed. |
| | This signal can be generalized to any core internal event of |
| | interest. |
| pip_cexe1_executed_ex | This signal indicates that a conditional block1 is executed. |
| | This signal can be generalized to any core internal event of |
| | interest. |
| pip_stall_ag | This signal is used to freeze the core pipeline from FD to AG |
| | stage. The ETM interface logic uses this information to filter |
| | out extra cycles due to pipeline stalls. |
| pip_stall_m0 | This signal is used to freeze the core pipeline from FD to M0 |
| | stage. The ETM interface logic uses this information to filter |
| | out extra cycles due to pipeline stalls. |
| pip_stall_m1 | This signal is used to freeze the core pipeline from FD to M1 |
| | stage. The ETM interface logic uses this information to filter |
| | out extra cycles due to pipeline stalls. |
| cpu_disc_pc_wb[23:0] | The discontinuity program counter. It is a new |
| | PC value if a non-sequential execution is performed. It is |
| | valid whenever there is a change in the instruction flow. |
| | Note that this is the taken PC for conditional branch. |
| cpu_etm_exc_trace_wb[7:0] | Execution trace packet. |
| cpu_etm_prof_wb[7:0] | Profile packet. |

Referring to FIGS. 6 and 7, in general, during the fetch/decode (FD) pipeline stage, the primary instruction decoder 500 provides opcode information of instructions being decoded therein to the program counter (PC) control logic 504 and the trace and profile logic 506. When a “discontinuity instruction” exists in the primary instruction decoder 500, the primary instruction decoder 500 provides “branch type” information to the program counter (PC) control logic 504 and the trace and profile logic 506.

As defined herein, a “discontinuity instruction” is an instruction that alters, or an instruction executed as a result of an altering of, a sequential fetching of instructions for execution. Examples of discontinuity instructions include branch instructions (conditional and unconditional), subroutine CALL instructions, RETURN instructions (e.g., RET instructions associated with subroutine CALL instructions and RETI instructions associated with interrupts), hardware loop instructions (e.g., AGNx instructions), and first instructions of interrupt service routines executed as a result of an interrupt request.

The program counter (PC) control logic 504 routinely determines an address at which instructions are to be fetched next from the memory system 106 of FIG. 1. This determination is normally based on a number of instructions grouped in the grouping (GR) pipeline stage and a current state of the processor core 104 of FIGS. 1 and 4. More specifically, the program counter (PC) control logic 504 normally determines an instruction fetch program counter (PC) value, conveyed by the fetch_pc_fd[23:01] signal (see Table 3), based on the number of instructions that are grouped in the grouping (GR) pipeline stage and the current state of the processor core 104. Herein below, the fetch_pc_fd[23:0] signal is referred to as the “fetch_pc_fd” signal.

When a discontinuity instruction exists in the fetch/decode (FD) pipeline stage (i.e., in the primary instruction decoder 500), the program counter (PC) control logic 504 uses a branch prediction scheme to update the instruction fetch program counter (PC) value (and the fetch_pc_fd signal) dependent upon the branch type information from the primary instruction decoder 500. Dependent upon the branch prediction scheme and the branch type information, the resulting “discontinuity address” may be the address of a next sequential instruction in the code 110 of FIG. 1, or a branch address specified by the discontinuity instruction.

During the next cycle of the CLOCK signal, the discontinuity instruction in the fetch/decode (FD) pipeline stage is stored in the instruction queue 508 of FIG. 6 awaiting instruction grouping by the grouping logic 510 of FIG. 6 in the grouping (GR) pipeline stage. The corresponding discontinuity address is specified by the fetch_pc_fd signal. If the discontinuity instruction is stored in the instruction queue 508 and grouped in the same cycle of the CLOCK signal, the current instruction fetch PC value (conveyed by the fetch_pc_fd signal) is provided to the read operand (RD) pipeline stage. In FIG. 7, the fetch_pc_fd signal is provided as the first discontinuity PC signal 1st_disc_pc[23:0] (see Table 3) to an input of an RD register of a shift register 610 having separate registers corresponding to the operand read (RD) stage, the address generation (AG), the memory access 0 (M0), and the memory access 1 (M1) pipeline stages.

On the other hand, if the discontinuity instruction is not stored in the instruction queue 508 and grouped in the same cycle of the CLOCK signal, the current instruction fetch PC value (conveyed by the fetch_pc_fd signal) is stored in an entry (i.e., “slot”) of a discontinuity first-in-first-out (FIFO) buffer 600 (i.e., “discontinuity FIFO 600”) of the trace and profile logic 506. In the embodiment of FIG. 7, the discontinuity FIFO 600 has four entries; however, any number of entries may be used depending on the number of instructions that can be handled in one clock cycle. For example, a 6-issue processor would use six entries, and so on for other wide-issue processors. Only one discontinuity instruction can enter the instruction queue 508 at a given time (i.e., during a given cycle of the CLOCK signal). Further, up to two discontinuity instructions can be grouped together in the grouping (GR) pipeline stage. Correspondingly, when two discontinuity instructions are grouped together in the grouping (GR) pipeline stage, the discontinuity FIFO 600 produces the two stored corresponding instruction fetch PC values simultaneously. In FIG. 7, a first of the two corresponding instruction fetch PC values is provided as the first discontinuity PC signal 1st_disc_pc[23:0] to the input of the RD register of a shift register 610, and the second corresponding instruction fetch PC value is provided as the second discontinuity PC signal 2nd_disc_pc[23:0] (see Table 3) to an input of an RD register of a shift register 612 similar to the shift register 610. The discontinuity FIFO 600 is thus essentially a single-input, parallel-output FIFO.

As noted above, in the embodiment of FIG. 7, the discontinuity FIFO 600 has four entries. In other embodiments, however, the discontinuity FIFO 600 may have other numbers of entries dependent on a number of instructions that can be grouped together for simultaneous execution during the grouping (GR) pipeline stage. For example, in a processor that can group n instructions together for simultaneous execution during the grouping (GR) pipeline stage, the discontinuity FIFO 600 may have n entries.

If the branch type information indicates an interrupt request has occurred, the discontinuity instruction is a first instruction of an interrupt service routine to be executed as a result of the interrupt request, and the fetch_pc_fd signal conveys an address of the first instruction of the interrupt service routine (i.e., the interrupt vector corresponding to the interrupt request). The fetch_pc_fd signal is provided to the read operand (RD) pipeline stage. In FIG. 7, the fetch_pc_fd signal is provided as the 1st_disc_pc[23:0] signal to the input of the RD register of the shift register 610. In addition, the address of the last instruction executed before the interrupt is serviced is also of interest. In FIG. 7, last PC executed logic 602 provides the last PC register value to the input of the RD register of the shift register 612.

If the branch type information indicates the discontinuity instruction is a register-based branch (BR) or subroutine CALL instruction, the discontinuity address (i.e. the discontinuity PC) is not known until the instruction enters the address generation (AG) pipeline stage. In such cases, the PC register value is either a value driven on a result bus corresponding to a first load/store unit 0 of the load/store unit 404 of FIG. 4, a value driven on a result bus corresponding to a second load/store unit 1 of the load/store unit 404, or the discontinuity PC in the address generation (AG) pipeline stage.

In FIG. 7, the input signal lsu0_res_ag[23:0] signal (see Table 3) provides the value driven on the load/store unit 0 (LSU0) result bus, the input signal lsu1_res_ag[23:0] (see Table 3) provides the value driven on the load/store unit 1 (LSU1) result bus, and an output signal of an AG register of the shift register 610, corresponding to the address generation (AG) pipeline stage, provides the discontinuity PC in the address generation (AG) pipeline stage. An appropriate one of those three signals is provided to an input of an MO register of the shift register 610 corresponding to the memory access 0 (MO) pipeline stage.

As described above, the embodiment of FIG. 7 reflects that up to two discontinuity instructions can be grouped together in the grouping (GR) pipeline stage (i.e., up to two discontinuity PC values can be generated simultaneously). Accordingly, the two discontinuity PC values need to be serialized before being sent to the trace port 412 of FIG. 4 during the write back (WB) stage. A serial queue 618 is realized by a special circular buffer with 4 entries or slots, two write ports, and one read port. A special update port of the serial queue 618 is used to update a valid entry with the latest discontinuity PC value in case a branch misprediction occurs. If the mispredicted branch is an oldest entry in the serial queue 618, the mispredict_pc_ex[23:0] signal is selected and sent to the trace port 412 during the write back (WB) stage.

A grouping (GR) type decoder 604 provides branch type information associated with the first and second discontinuity PC values to a shift register 614. The shift register 514 provides the branch type information to the serial queue 618. Branch taken information associated with the first and second discontinuity PC values is also provided to the serial queue 618. The branch type information and the branch taken information associated with the first and second discontinuity PC values are also stored serial queue 618 and sent out with their respective discontinuity PC values during the write back (WB) stage.

Profile information logic 606 includes hardware loop detection logic and branch prediction logic, and provides branch misprediction and conditional execution instruction information to a shift register 616. In the execution (EX) pipeline stage, the branch misprediction and conditional execution instruction information provided by the shift register 616 are used to correct branch taken and conditional execution instruction information.

It is noted that all M1 and EX registers of the shift registers 610, 612, 614, and 616 can be flushed by a branch misprediction and other conditions. The registers of the shift registers 610, 612, 614, and 616 can also be stalled due to a number of conditions, including the ETM stall. As described above, the pipeline control unit 410 responds to the asserted ETM STALL signal from the ETM/EPU 112 of FIG. 1 by stalling the execution pipeline. Accordingly, special stall filtering logic 608 is needed to remove repeated, redundant information generated during stall cycles in the execution (EX) pipeline stage.

As indicated in FIG. 7, the stall filtering logic 608 receives a “pip_stall_ag” signal, a “pip_stall_m0” signal, and a “pip_stall_m1” signal, and produces a “stall_clear ex” signal. The pip_stall_ag signal is asserted to stall instructions in the fetch/decode (FD), the grouping (GR), the operand read (RD), and the address generation (AG) stages of the pipeline. The pip_stall_m0 signal is asserted to stall instructions in the fetch/decode (FD), the grouping (GR), the operand read (RD), the address generation (AG), and the memory address 0 (MO) stages of the pipeline. The pip_stall_m1 signal is asserted to stall instructions in the fetch/decode (FD), the grouping (GR), the operand read (RD), the address generation (AG), the memory address 0 (M0), and the memory address 1 (M1) stages of the pipeline. During the execution (EX) pipeline stage, the stall filtering logic 608 asserts the stall_clear ex signal for an appropriate number of cycles of the CLOCK signal (see FIGS. 1 and 4) dependent upon the pip_stall_ag, the pip_stall_m0, and the pip_stall_m1 signals to eliminate repeated, redundant information, generated due to pipeline stalls.

Based on the three stall input signals, the stall filtering logic 608 determines how many cycles a specific event has been stalled before entering the execution (EX) pipeline stage. For example, if an event was stalled for two cycles of the CLOCK signal (see FIGS. 1 and 4) when in the address generation (AG) stage, and one cycle when it was in memory address 1 (M1) stage, the event would appear four times during the execution (EX) stage. The stall filtering logic 608 would assert the stall_clear_ex signal for three cycles when the event is in the execution (EX) pipeline stage to remove the three extra occurrences of the event introduced due to the stall conditions.

Additional details of conditional instruction execution will now be described. Referring to FIGS. 1 and 4, the conditional execution instruction 116 is typically one of several instructions (e.g., 6 instructions) fetched from the memory system 106 by the instruction unit 400 and decoded during the fetch/decode (FD) stage. During the execution (EX) stage of the conditional execution instruction 116, the register specified by the conditional execution instruction 116 (e.g., a flag register or one of the general purpose registers) is accessed. The execution unit 406 may test the specified register for the specified condition, and provide a comparison result to the pipeline control unit 410.

As described above, if the conditional execution instruction 116 specifies the hardware flag register, the values of the flag bits in the hardware flag register are copied to the corresponding flag bits in the static hardware flag register. For example, if the conditional execution instruction 116 specifies the hardware flag register, the pipeline control unit 410 may produce a signal that causes the values of the flag bits in the hardware flag register to be copied to the corresponding flag bits in the static hardware flag register.

During the execution (EX) stage of each of the instructions of the code block 118, the pipeline control unit 410 may provide a first signal and a second signal to the execution unit 406. The first signal may be indicative of the value of the pointer update bit 206 of the conditional execution instruction 116 specifying the code block 118, and the second signal may be indicative of whether the specified condition existed in the specified register during the execution (EX) stage of the conditional execution instruction 116.

During the execution (EX) stage of a load/store with update instruction of the code block 118, if the first signal indicates that the pointer update bit 206 of the conditional execution instruction 116 specifies that the pointer used in the load/store instruction is to be updated unconditionally, that is independent of the condition specified by the conditional execution instruction 116, the execution unit 406 updates the pointer used in the load/store instruction.

On the other hand, if the first signal indicates that the pointer update bit 206 of the conditional execution instruction 116 specifies that the pointer used in the load/store instruction is to be updated only if the condition specified by the conditional execution instruction 116 is true, the execution unit 406 updates the pointer used in the load/store instruction dependent upon the second signal. If the second signal indicates the specified condition existed in the specified register during the execution (EX) stage of the conditional execution instruction 116, the execution unit 406 updates the pointer used in the load/store instruction. On the other hand, if the second signal indicates that the specified condition did not exist in the specified register during the execution (EX) stage of the conditional execution instruction 116, the execution unit 406 does not update the pointer used in the load/store instruction.

During the execution (EX) stage of each of the instructions of the code block 1118, the execution unit 406 saves results of the instructions of the code block 118 dependent upon the second signal provided by the pipeline control unit 410. For example, during the execution (EX) stage of a particular one of the instructions of the code block 118, if the second signal received from the pipeline control unit 410 indicates the specified condition existed in the specified register during the execution (EX) stage of the conditional execution instruction 116, the execution unit 406 provides the results of the instruction to the register file 408. On the other hand, if the second signal indicates the specified condition did not exist in the specified register during the execution (EX) stage of the conditional execution instruction 116, the execution unit 406 does not provide the results of the instruction to the register file 408.

If the condition specified by the conditional execution instruction 116 of FIG. 1 is true, the results of the instructions making up the code block 118 of FIG. 1 are qualified, and the results are written to the register file 408 during the corresponding execution (EX) stages. If the specified condition is not true, the results of the instructions of the code block 118 are not qualified, and are not written to the register file 408 during the corresponding execution stages (i.e., are ignored).

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below. What we claim as our invention is:

1. A processor, comprising:
trace and profile logic, comprising:
a discontinuity buffer for storing data corresponding to a discontinuity instruction subject to grouping with other instructions for simultaneous execution during an instruction grouping stage of an instruction execution pipeline implemented within the processor.

2. The processor as recited in claim 1, wherein the discontinuity instruction comprises an instruction that alters, or is executed as a result of an altering of, a sequential fetching of instructions.

3. The processor as recited in claim 1, wherein the discontinuity instruction comprises either a branch instruction, a subroutine CALL instruction, a RETURN instruction, a hardware loop instruction, or a first instruction of an interrupt service routine executed as a result of an interrupt request.

4. The processor as recited in claim 1, wherein the data corresponding to the discontinuity instruction comprises a fetch address used to fetch the discontinuity instruction.

5. The processor as recited in claim 1, wherein the data corresponding to the discontinuity instruction comprises an instruction fetch program counter value used to fetch the discontinuity instruction.

6. The processor as recited in claim 1, wherein the other instructions comprise instructions residing in an instruction queue and awaiting instruction grouping.

7. The processor as recited in claim 1, wherein the instruction grouping stage follows an instruction fetch and decode stage during which the discontinuity instruction was fetched.

8. The processor as recited in claim 1, wherein the discontinuity buffer comprises a plurality of entries, and wherein data corresponding to only a single discontinuity instruction can be stored in the discontinuity buffer during a store operation, and wherein the discontinuity buffer is configured to provide data corresponding one or more discontinuity instruction during a retrieve operation.

9. The processor as recited in claim 1, wherein in the event two discontinuity instructions having corresponding data stored in the discontinuity buffer are grouped together for simultaneous execution during the instruction grouping stage, the discontinuity buffer is configured to produce the data corresponding to the two stored discontinuity instructions simultaneously.

10. The processor as recited in claim 1, wherein the trace and profile logic is configured to gather and produce data corresponding to events occurring during instruction execution.

11. A processor, comprising:
trace and profile logic, comprising:
a serial queue for serializing data corresponding to a plurality of discontinuity instructions grouped together for simultaneous execution.

12. The processor as recited in claim 11, wherein the discontinuity instructions comprise discontinuity instructions grouped together for simultaneous execution during an instruction grouping stage of an instruction execution pipeline implemented within the processor.

13. The processor as recited in claim 11, wherein each of the discontinuity instructions comprises an instruction that alters, or is executed as a result of an altering of, a sequential fetching of instructions.

14. The processor as recited in claim 13, wherein each of the discontinuity instructions comprises either a branch instruction, a subroutine CALL instruction, a RETURN instruction, a hardware loop instruction, or a first instruction of an interrupt service routine executed as a result of an interrupt request.

15. The processor as recited in claim 11, wherein the data corresponding to each of the discontinuity instructions comprises a fetch address used to fetch the discontinuity instruction.

16. The processor as recited in claim 11, wherein the data corresponding to each of the discontinuity instructions comprises an instruction fetch program counter value used to fetch the discontinuity instruction.

17. The processor as recited in claim 11, wherein the serial queue comprises a circular buffer with a plurality of entries, a write port, and a read port.

18. The processor as recited in claim 17, wherein the serial queue comprises an update port used to update data stored in the serial queue.

19. The processor as recited in claim 17, wherein the serial queue comprises an update port used to update a valid entry of the serial queue with a correct instruction fetch program counter value in the event an outcome of a conditional branch instruction was mispredicted.

20. A processor, comprising:
trace and profile logic, comprising:
stall filtering logic coupled to receive at least one input signal indicative of a stall condition in an instruction execution pipeline implemented within the processor, and configured to assert an output signal for a period of time during which repeated, redundant data generated due to the stall condition are to be ignored.

21. The processor as recited in claim 20, wherein the at least one input signal is asserted to stall executions of instructions in a plurality of stages of the instruction execution pipeline.

22. The processor as recited in claim 20, wherein the stall filtering logic uses the at least one input signal to determine the period of time during which the repeated, redundant data generated due to the stall condition are to be ignored.

23. The processor as recited in claim 20, wherein the instruction execution pipeline comprises a plurality of stages, and wherein instructions remain in each stage for a fixed number of cycles of a clock signal, and wherein the stall filtering logic uses the at least one input signal to determine a number of clock cycles during which the repeated, redundant data generated due to the stall condition are to be ignored.

24. A system, comprising:
a processor coupled to a memory system via at least one bus and configured to fetch instructions from the memory system and to execute the instructions, wherein the processor is capable of executing multiple instructions simultaneously, and wherein the processor comprises:
trace and profile logic configured to gather and produce event data during instruction execution, wherein the trace and profile logic comprises a discontinuity buffer for storing data corresponding to a discontinuity instruction subject to grouping with other instructions for simultaneous execution during an instruction grouping stage of an instruction execution pipeline implemented within the processor;
an embedded trace module/embedded profile unit (ETM/EPU) coupled to the at least one bus and to the processor, and configurable to receive the event data from the processor, and to provide the event data; and
a computer system coupled to receive the event data from the ETM/EPU and configurable to present the event data to a user.
